(19) United States
(12) Patent Application Publication
(10) Pub. No.: US 2023/0401854 A1
(43) Pub. Date: Dec. 14, 2023

(54) MONITORING SYSTEM RULE GENERATION

(71) Applicant: ObjectVideo Labs, LLC, Tysons, VA (US)

(72) Inventors: Ethan Shayne, Clifton Park, NY (US); Donald Gerard Madden, Columbia, MD (US)

(21) Appl. No.: 18/208,675

(22) Filed: Jun. 12, 2023

Related U.S. Application Data
(60) Provisional application No. 63/351,546, filed on Jun. 13, 2022.

(51) Int. Cl. G06V 20/52; G06T 17/00; G06T 13/40; G08B 21/00

(52) U.S. Cl. CPC G06V 20/52; G06T 17/00; G06T 13/40; G08B 21/00

(57) ABSTRACT

Methods, systems, and apparatus, including computer programs encoded on computer-storage media, for generating rules for a monitoring system. In some implementations, a method includes presenting a virtual model of a monitoring system of a property; obtaining action data from a computer generated avatar in the virtual model; generating a security rule for the monitoring system using the action data from the computer generated avatar in the virtual model; and providing, to the monitoring system, the security rule to cause the monitoring system to generate, using the security rule and sensor data from the property received by the monitoring system, a security alert.

### CROSS-REFERENCE TO RELATED APPLICATION

This application claims the benefit of U.S. Provisional Application No. 63/351,546, filed Jun. 13, 2022, the contents of which are incorporated by reference herein.

### BACKGROUND

A monitoring system for a property can include various components including sensors, e.g., cameras, and other devices. For example, the monitoring system may use the camera to capture images of people or objects of the property.

### SUMMARY

This specification describes techniques, methods, systems, and other mechanisms for training and generating security rules in a virtual reality environment. A virtual model of a property is generated including one or more three dimensional (3-D) elements corresponding to real world elements at the given property. By controlling an avatar within the virtual model or obtaining real world data from sensors of a property, a control unit can determine one or more rules. Rules can be used to determine if one or more actions detected by one or more sensors on a property are acceptable or not acceptable, or whether an action should trigger an alert, according to preferences of a user.

Current methods of generating rules require either direct programming or manual annotation of maps or images. To improve monitoring system security and efficiency of rule generation, features described herein enable a user to demonstrate actions in a virtual model of a property that correspond to acceptable behavior or actions that are not acceptable (e.g., dangerous to property or person). Particularly for not acceptable behavior, it may be safer for a user to demonstrate in virtual reality as opposed to the real world. For example, a large corpus of real world data is not necessarily required. A virtual reality system as discussed herein can be used to artificially increase a size of training data and inform rule generation. Using virtual demonstrations, a control unit can generate one or more rules. The control unit can provide feedback to a user indicating the generated rules or simulated behavior that would trigger alerts. A user can confirm or deny generated rules. Generated rules can be enforced by a monitoring system at a real world property.

The subject matter described in this specification can be implemented in various implementations and may result in one or more of the following advantages. For example, the systems described may generate a more generalized and protective rule using examples. A user may provide input indicating a “good” example of someone walking down the sidewalk, and a counter-example of someone walking across the grass. The systems described in this document can determine that walking off of the sidewalk at any location along the sidewalk is a “bad” behavior or, in other words, is not acceptable. Such a rule can be generated without a user individually indicating areas for access and non-access, such as virtual trip wires or defining explicitly what a sidewalk or grass is to the system.

Techniques described can allow rule generalization that identifies areas where it may be difficult to enforce demonstrated behavior. In response to determining one or more areas where it may be difficult to enforce demonstrated behavior, systems described can notify a user. For example, in the sidewalk example above, a system can identify a portion of a sidewalk that is not monitored by cameras, or a section of a field of view where a tree or other object occludes the sidewalk or a boundary between sidewalk and grass.

Because a system can encode behavior to be enforced—e.g., rather than explicit geometry assigned by a user—the system can identify blind spot areas to the user. In some cases, commercial properties cover a larger area than residential. A generalized rule-by-example approach may be significantly more time-efficient for a commercial application than specifying individual rules throughout an entire commercial property. Generalized rules can be applied across cameras or across different locations without requiring specific per camera or per site configuration.

In general, one innovative aspect of the subject matter described in this specification can be embodied in methods that include the actions of presenting a virtual model of a property that includes a monitoring system; obtaining action data from a computer generated avatar in the virtual model; generating a security rule for the monitoring system using the action data from the computer generated avatar in the virtual model; and providing, to the monitoring system, the security rule to cause the monitoring system to generate, using the security rule and sensor data from the property received by the monitoring system, a security alert.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In some implementations, generating the security rule using the action data includes determining movement vectors of the avatar moving in the virtual model; and determining, using the movement vectors, regions represented in the virtual model accessed by the avatar.

In some implementations, generating the security rule using the action data includes: generating a virtual image stream representing images from a viewpoint corresponding to a real camera of the monitoring system of the property; and generating, using the virtual image stream, the security rule. In some implementations, actions include obtaining monitoring information of the monitoring system of the property; and generating the virtual model of the property using the monitoring information of the monitoring system of the property.

In some implementations, actions include obtaining user input provided by a user input device representing the action data of the computer generated avatar in the virtual model, wherein the computer generated avatar is controlled using the user input.

In some implementations, actions include obtaining user input requesting that one or more actions represented in the action data trigger one or more security alerts, wherein the one or more security alerts include the security alert.

In some implementations, actions include providing the security rule to a device of the monitoring system; obtaining feedback of the security rule from the device; and updating, in response to obtaining the feedback of the security rule, a security rule database for use by the monitoring system of the property. In some implementations, updating the security rule database includes: storing the security rule in the security rule database. In some implementations, actions include updating, in response to obtaining the feedback of the security rule, the security rule; and updating the security rule database by storing the updated security rule in the security rule database. In some implementations, providing the security rule to the device of the monitoring system includes providing data indicating a virtual representation of the avatar performing an action in the virtual model to a device of a user.

In some implementations, generating the security alert using the security rule includes: transmitting sensor data from the monitoring system of the property to a device of the monitoring system, wherein the sensor data represents an action satisfying one or more thresholds of the security rule.

In some implementations, generating the security rule using the action data includes: determining a plurality of thresholds including one or more thresholds for movement of an object and one or more thresholds for features of the object. In some implementations, determining the plurality of thresholds includes: determining the one or more thresholds for movement including a position threshold indicating whether a person is moving on or off a pathway.

In some implementations, generating the security rule includes: detecting input indicating an identifier for a specific person; determining, using the action data from the computer generated avatar in the virtual model, an action for the specific person; and generating the security rule that (i) includes the identifier for the specific person and (ii) identifies the action that applies to the specific person using the identifier.

In some implementations, generating the virtual model of the property includes: generating a virtual representation of a home and one or more elements within a threshold distance of the home.

In some implementations, obtaining the action data from the computer generated avatar in the virtual model includes: obtaining actions of the computer generated avatar walking off a path at the property in the virtual model of the property.

In some implementations, actions include providing data captured by the monitoring system of the property to a device of a user; and obtaining feedback from the device of the user indicating if the data captured by the monitoring system of the property includes acceptable or not acceptable actions.

In some implementations, actions include obtaining audio input as at least part of the action data; and generating, using the audio input, the security rule for the monitoring system.

In some implementations, determining the plurality of thresholds includes determining the one or more thresholds for features including a face threshold indicating whether a person is wearing or not wearing a face covering.

In some implementations, actions include obtaining sensor data from the monitoring system of the property; comparing the sensor data from the monitoring system of the property to one or more thresholds of the security rule; and generating, using the comparison of the sensor data from the monitoring system of the property to the one or more thresholds of the security rule, the security alert.

The subject matter described in this specification can be implemented in various implementations and may result in one or more of the following advantages. In some implementations, systems and methods described in this specification improve accuracy by generating more accurate rules using avatar action data for a virtual model. This can reduce false positives, false negatives, or both. In some implementations, systems and methods described in this specification reduce computational resource usage. For example, by inferring rule parameters—e.g., for multiple cameras using an input example for a single camera, a system for rule generation can reduce computational resource usage that would traditionally be required for inputting and processing individual rules for each individual camera or other sensor.

Demonstrating bad behavior virtually may be safer, easier, and less expensive than doing so physically—e.g., throwing a brick through a window or generating rules involving large groups of people, traveling long distances, among others. Using a virtual reality (VR) system can allow a system to provide feedback in the form of examples. For example, systems described in this document can virtually demonstrate that a person walking across grass is considered a rule violation. Using VR for system feedback can provide clearer, easier to understand feedback of the resulting rule(s). For example, drawing an area of interest (AOI) on a two-dimensional image may not provide as clear an indication of an actual rule as compared to allowing a user to virtually inspect AOI borders in VR. By combining a virtual demonstration of unwanted behavior along with a verbal explanation, systems can allow users to more easily disambiguate rules. For example, by virtually throwing a brick through a window while simultaneously explaining that bricks through any window is a violation (e.g., not just the one demonstrated).

In some implementations, rule creation or demonstration is decoupled from a 2D camera projection. Systems described in this document can identify where the system or camera may not be able to accurately detect a rule. For example, a user can demonstrate a rule indicating that people entering a certain area triggers a rule violation. However, that area can be partially occluded by an obstacle or is far enough away from the camera that the image processing may not accurately detect objects such that a rule will not trigger accurately. The system can use a model (such as a three-dimensional model) to determine these deficiencies and alert a user that a rule may not trigger properly. The system can visualize or demonstrate one or more particular issues in VR to the user.

The details of one or more embodiments of the invention are set forth in the accompanying drawings and the description below. Other features and advantages of the invention will become apparent from the description and the drawings.

### BRIEF DESCRIPTION OF THE DRAWINGS

FIG. 1 is a diagram showing an example of a system for monitoring system rule generation.

FIG. 2 is a diagram showing an example of an action engine and rule engine for monitoring system rule generation.

FIG. 3 is a diagram showing an example of an action engine and rule engine performing feature analysis and movement analysis for monitoring system rule generation.

FIG. 4 is a flow diagram illustrating an example of a process for monitoring system rule generation.

FIG. 5 is a diagram illustrating an example of a property monitoring system.

Like reference numbers and designations in the various drawings indicate like elements.

### DETAILED DESCRIPTION

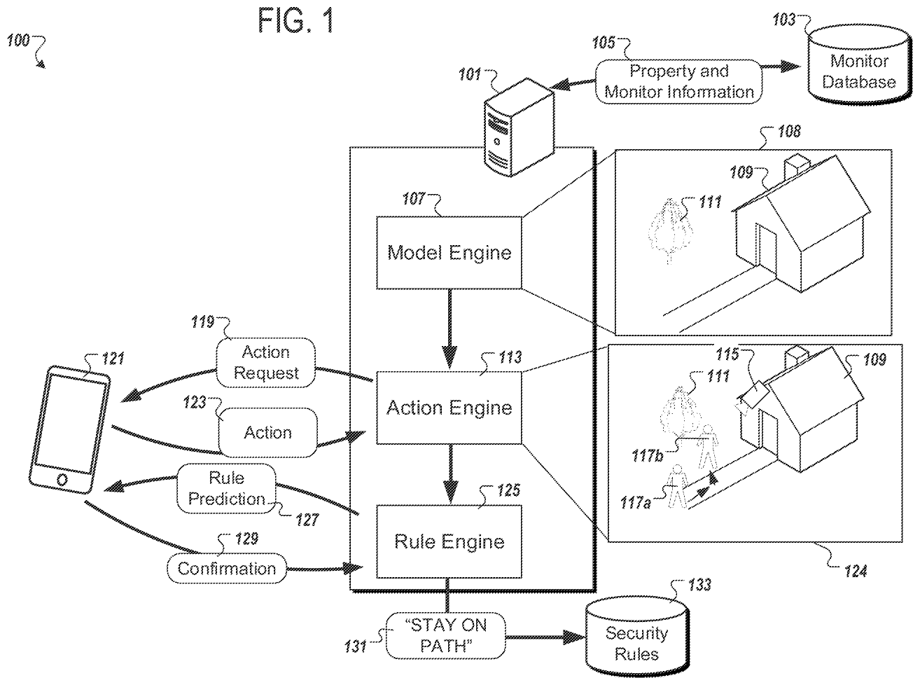

FIG. 1 is a diagram showing an example of a system 100 for monitoring system rule generation. The system 100 includes a control unit 101 and a device 121 of a user. The control unit 101 accesses information from a monitor database 103 and security rules 133. The control unit 101 is communicably connected to the device 121, e.g., a virtual reality (VR) headset, handheld device, among others. The control unit 101 generates or obtains a virtual model of a property. Based on events within the virtual model, the control unit 101 determines one or more rules to add to the security rules 133. These rules can be used in one or more monitoring systems to determine rule violations and generate alerts or perform other actions. The control unit 101, or a device communicably connected to the control unit 101, e.g., a server, can include one or more processors that execute instructions to operate model engine 107, action engine 113, and a rule engine 125.

Example rules can include staying on a path and not walking on a lawn, approaching the front door and not a side door, not throwing items at a house, among many others. A user can control an avatar within a virtual model and perform either acceptable actions or actions that should violate a rule. The control unit 101 can determine one or more rules based on the actions provided by a user.

Initially, the control unit 101 obtains or generates a virtual model of a property. For example, the control unit 101 obtains property and monitor information 105 from the monitor database 103. The property and monitor information 105 can include a virtual model. The property and monitor information 105 can include details for generating a virtual model. The control unit 101 can generate a virtual model based on the property and monitor information 105 or obtain a virtual model from the property and monitor information 105.

The control unit 101 can generate one or more events within this virtual model to determine one or more rules to enhance a monitoring system's security. In the example of FIG. 1, model engine 107 of the control unit 101 generates or obtains a virtual model, shown graphically in image 108. The virtual model includes a virtual representation of a house 109 and various other elements, including a tree 111. In some implementations, the elements of the virtual model correspond to actual elements on an actual property, that will be on the actual property, e.g., when a renovation may occur, or both. In this way, the control unit 101 can determine how rules might change given potential changes to the actual property and update the rules, create new rules, or both, e.g., to improve an accuracy of the rules. In some implementations, a user can enter a virtual copy of a property using a device or other interface connected to the control unit 101.

The model engine 107 provides the virtual model to an action engine 113. The action engine 113 generates events, e.g., autonomously or using input from a user, within the virtual model from which the rule engine 125 determines a rule to subsequently enforce, e.g., in an actual monitoring system. In the example of FIG. 1, the device 121 of a user is communicably connected to the control unit 101. In some implementations, a user directly controls elements of the virtual model. For example, instead of using an intermediary, such as the device 121, the user can directly provide control data to the control unit 101 configured to generate one or more events. In some implementations, the device 121 is an interface for providing control data directly to the control unit 101. In some implementations, the device 121 is a standalone device, such as a smartphone, laptop, among others.

In the example of FIG. 1, the action engine 113 provides an action request 119 to the device 121. In response to the action request 119, the device 121, controlled by a user, provides data of an action 123 to the action engine 113. In some implementations, the device 121 provides the action 123 without first receiving the action request 119. For example, the control unit 101 can respond to data sent from a device, such as the device 121, indicating an action, such as the action 123. In some implementations, the action 123 can demonstrate a specific type of issue a user wants to be considered a rule violation or activities they want to trigger alerts.

In the example of FIG. 1, the action 123 includes data indicating walking off a path leading to the house 109. The action engine 113 generates the action 123 in the virtual model. The action 123 is shown graphically, within the virtual model, in image 124. The image 124 shows a graphical representation of an avatar 117a at a first time and position and an avatar 117b at a second time and position. The avatar 117a and 117b show the movement indicated by the action 123. The control unit 101 initiates a virtual camera 115 positioned on the property to record the action. The position of the camera 115 can correspond to an actual position of a camera on a real world property.

The rule engine 125 determines a rule 131 using the data generated within the virtual model by the action engine 113. In some implementations, the rule engine 125 uses a virtual image stream from the camera 115 to detect the action 123 in the virtual model. In some implementations, a user indicates that an action should be accepted by a system or an action should not be accepted. For example, a user can provide input to the control unit 101 indicating that a subsequent action is an action the user wants to prevent at a property. In some implementations, user input requests that one or more actions represented in the data generated within the virtual model by the action engine 113 trigger one or more security alerts. Using this input, the rule engine 125 can generate a rule, such as the rule 131, where actions similar to the action 123 are determined as violations and subsequent actions can be taken by a monitoring system.

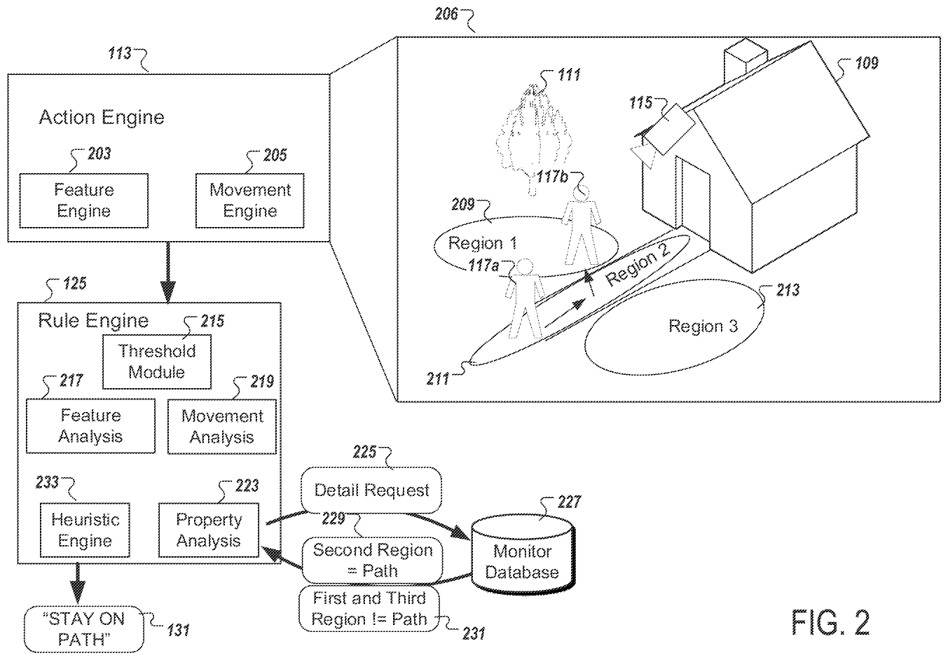

In this case, the rule engine 125 determines a rule prediction 127 indicating that a person approaching the house 109 must stay on the path. The process for this determination is described in later figures, including FIG. 2. In the example of FIG. 1, the rule engine 125 sends the device 121 the rule prediction 127. In some examples, the rule engine 125 does not send the rule prediction 127 to the device 121.

The device 121 can provide data in return indicating whether or not the rule prediction 127 should be stored and enforced. In this case, the device 121 provides confirmation 129. In some implementations, the device 121 provides a negative response. For example, a user of the device 121 can interact with the device 121 and determine, using a graphical, textual, or other representation of the rule prediction 127, whether the rule prediction 127 corresponds to a rule the user intended to showcase, a rule the user wants to have stored and enforced, a rule that the user does not want to enforce, or a rule that the user did not intend to showcase.

In some implementations, the rule prediction 127 the rule engine 125 configures the rule prediction 127 with data such that, after being received by a receiving device, such as the device 121, a display element of the receiving device displays a graphical representation of the rule prediction 127. The graphical representation can include a visual depiction of an example action that would either violate or not violate the rule. The visual depiction can include visuals from the virtual model generated or obtained by the model engine 107. The visual depiction can include text. The text can describe the actions that would be in violation or would not be in violation.

The rule engine 125 stores the rule 131 in the security rules 133. The security rules 133 can include computer memory storage to store one or more security rules. In some implementations, the rule engine 125 determines the rule 131 and directly stores the rule in the security rules 133 without sending a prediction to the device 121. For example, the rule engine 125 can determine, based on actions performed by the action engine 113 corresponding to one or more elements of the virtual model, e.g., the avatar 117a-b, the house 109, among others, the rule 131. The rule engine 125 can then store the rule 131 in the security rules 133.

In some implementations, a user provides input to the control unit 101 indicating that a subsequent action is an action to enforce at a property. Using this input, the rule engine 125 can generate a rule, such as the rule 131. In a monitoring system scenario, actions similar to the action 123 can be determined as acceptable or not acceptable based on the input provided by a user. The input can be provided by a user using a device, such as the device 121, communicably connected to the control unit 101. In some implementations, actions sufficiently dissimilar to the action 123 are violations, e.g., if the input indicates the action 123 is acceptable, or not violations, e.g., if the input indicates the action 123 is not acceptable. Subsequent actions can be taken by a monitoring system after determining a violation or non-violation using a generated rule.

In some implementations, actions are valued. For example, the control unit 101 can determine one or more values for a computer generated person or real person approaching or moving in a property. Values can include deviations from a known acceptable path—e.g., along a pathway from a road or driveway to a door. A path extending beyond detected boundaries of a pathway can be given, by the control unit 101, a value proportional to the distance beyond the boundary. In some implementations, the control unit 101 can determine Boolean values for actions. For example, a Boolean value indicating whether or not an action is acceptable can be determined by the control unit 101 using computer generated data or real world data from a monitoring system at a real property. A path extending beyond a detected boundary of a pathway can be given, by the control unit 101, a Boolean value indicating the action is not acceptable.

In response to detecting not acceptable actions, the control unit 101 can transmit one or more signals configured to alert or notify one or more users—e.g., transmitting a notification indicating one or more not acceptable actions to a user device. Actions can be indicated using textual displays—e.g., describing one or more actions—or graphical displays—e.g., showing not acceptable actions, such as stored computer generated actions similar to a detected not acceptable action or real world monitoring data indicating an instant not acceptable action that prompted the notification or alert. In some implementations, alerts or notifications include alerting or notifying emergency personnel or law enforcement. For example, an action of breaking a window can be sufficient for the control unit 101 to transmit information of the action to law enforcement indicating information of the action—e.g., location, time, among others. In general, the control unit 101 can transmit any type of data recorded in monitoring system data to emergency personnel or law enforcement in response to detecting one or more actions. A user can identify what types of actions should trigger alerting or notifying emergency personnel or law enforcement.

Similarity for either a violating or non-violating case can be determined by one or more thresholds. A rule can indicate features of one or more events corresponding to one or more actions at a point in time or over a range of time. A monitoring system can obtain real world data and compare the real world data to the rule features to determine if the real world data satisfies one or more thresholds. Satisfying one or more thresholds can indicate that a monitoring system alert a user. Satisfying one or more thresholds can indicate that a monitoring system not alert a user. The control unit 101 can determine the type of alert or response, e.g., alerting the user, alerting the user and a central station, among others, using one or more thresholds.

In some implementations, the control unit 101 performs operations of a monitoring system. For example, the control unit 101 can use a generated rule, such as rule 131, in a real world monitoring system to determine whether actions at a real world property monitored by the monitoring system violate or do not violate the generated rule.

FIG. 2 is a diagram showing an example of the action engine 113 and the rule engine 125 for monitoring system rule generation. FIG. 2 illustrates how the action engine 113 and the rule engine 125 generate actions and determine rules corresponding to the actions, respectively. The example of FIG. 2 shows the action engine 113 including a feature engine 203 and movement engine 205. The rule engine 125 includes a threshold module 215, a feature analysis 217, a movement analysis 219, a property analysis 223, and a heuristic engine 233. The feature engine 203, the movement engine 205, the threshold module 215, the feature analysis 217, the movement analysis 219, the property analysis 223, and the heuristic engine 233 can be realized by one or more computer processors of the control unit 101, or a communicably connected device, e.g., remote device, server, among others.

The action engine 113 generates actions within a virtual model, graphically shown in image 206, as discussed with respect to FIG. 1. In this example, the action includes walking off the path. In general, any real world action can be simulated in the virtual model. For example, any action that could occur in the real world could be simulated in the virtual model. The simulation of the real world action can then be used to generate a rule for enforcement in a real world, e.g., physical world, monitoring system.

The feature engine 203 and the movement engine 205 operate to generate actions in the virtual model. The feature engine 203 can generate features of elements within the virtual model. The movement engine 205 can generate movement of elements in the virtual model. In some implementations, the action engine 113 includes other modules to realize actions within the virtual model. In the example of walking off the path, the movement engine 205 generates movement of the avatar 117a-b as discussed in FIG. 1.

The action engine 113 provides data corresponding to actions depicted in the virtual model to the rule engine 125. The rule engine 125 performs analysis on the data to determine the rule 131. The rule 131 can include one or more thresholds to determine if obtained data satisfies or does not satisfy the rule 131.

In the example of FIG. 2, the rule engine 125 includes a threshold module 215, feature analysis 217, and movement analysis 219. In some implementations, the rule engine includes an analysis module configured to perform analysis on features and movement. In some implementations, the threshold module 215 of the rule engine 125 determines a primary analysis to perform. For example, the threshold module 215 can perform feature analysis 217 and movement analysis 219. If the action depicted in the virtual model satisfies a movement threshold, the movement analysis 219 is performed. If the action depicted in the virtual model satisfies a feature threshold, the feature analysis 217 is performed.

In general, rules can be enforced for movement actions as well as features. For example, certain movement on a property can be acceptable, e.g., walking on a path, while other movement can be unacceptable, e.g., walking off a path. Similarly, some features can be acceptable, e.g., person approaching front door without face covering, and some features can be unacceptable, e.g., wearing a face covering.

In some implementations, weather, or other environmental variables at a property, e.g., light, property status, among others, are used to determine a rule. For example, wearing a ski mask in summer walking towards the front door at night can be unacceptable. Wearing a surgical mask during a viral epidemic or outbreak when approaching the front door can be acceptable.

The threshold module 215 can determine to perform the feature analysis 217 and the movement analysis 219, or only one or the other. For example, if the distance moved by a moving element is over a threshold distance, the threshold module 215 can determine that only the movement analysis 219 should be performed. If movement does not satisfy the threshold, or satisfies a minimum threshold, the feature analysis 217 can be performed. If no movement is detected or movement does not satisfy a threshold, the threshold module 215 can perform only the feature analysis 217.

In the example of FIG. 2, the rule engine 125 performs the movement analysis 219. As part of the movement analysis, the rule engine 125 determines movement vectors shown graphically in image 206 for the avatar 117a-b as the avatar moves from the location corresponding to avatar 117a to the location corresponding to the avatar 117b. The rule engine 125 can determine the exact movement vectors within the virtual model of one or more elements represented in the virtual model, including the avatar 117a-b. A resulting rule can include one or more motion vectors including one or more thresholds of acceptable or not acceptable motions.

The rule engine 125 performs property analysis 223. The rule engine 125 can determine specific features of a property pertinent to a rule. For example, a property may have distinguishable features, such as path regions and non-path regions. Determining these features can inform the rule generation process as the rule can be generated in relation to the features of the property. In the example of FIG. 2, the rule engine 125 queries the monitor database 227 with the detail request 225. The rule engine 125 can access information stored in the monitor database 227 about a property represented in the virtual model. The monitor database 227 can be stored in memory of the control unit 101 or in memory of a device communicably connected to the control unit 101.

In some implementations, the detail request 225 includes an identifier of the property. For example, one or more property details can be stored in the monitor database 227. Each property can have an identifier associated with it. The rule engine 125 can query the database 227 using a specific identifier for a property to get information about that property.

In the example of FIG. 2, as part of the property analysis 223, the rule engine 125 obtains information about the regions of the property, including a first region 209, a second region 211, and a third region 213. The second region 211 corresponds to the path. Although shown graphically as ovals, the regions can be stored as any shape or region in memory of an operating device, such as the control unit 101. The rule engine 125, e.g., as part of the property analysis 223, can obtain pre-generated information about the property or can obtain raw data from the virtual model and, using one or more visual or analytic processing, identify features at the property. The features may be tagged or otherwise annotated in the virtual model. If there are no such annotations, the rule engine 125, e.g., as part of the property analysis 223, can determine features.

In some implementations, the rule engine 125, e.g., as part of the property analysis 223, determines one or more features relevant for the actions depicted in the virtual model. For example, if actions affect certain areas or elements of a property, the rule engine 125, e.g., as part of the property analysis 223, can determine what features correspond to those affected areas or elements. For example, if an action affects a flower pot, the rule engine 125, e.g., as part of the property analysis 223, can determine that a corresponding object represented in the virtual model is a flower pot. If an action affects a certain area, the rule engine 125, e.g., as part of the property analysis 223, can define the area using a heuristic engine 233. The engine 233 can include one or more neural networks trained to detect features based on labeled training data. Features represented within the virtual model can be detected by the engine 233.

The engine 233 and the rule engine 125 generate the rule 131. The rule engine 125, e.g., as part of the property analysis 223, obtains information about the regions including the second region 211 is a path in data 229 and that the first and third region are not the path in data 231. The rule engine 125, e.g., as part of the property analysis 223, can use the heuristic engine 233 to determine the information based on property information obtained from the monitor database 227.

The rule engine 125 determines, based on the motion vectors for the avatar 117a-b and the features of the property represented in the virtual model, the movement of the avatar 117a-b corresponds to moving from the second region 211 to the first region 209. In some implementations, the heuristic engine 233 includes rule heuristics. For example, the heuristic engine 233 can include one or more algorithms or neural networks to determine, based on a detected action, typical rules associated with the action. Typical rules can include staying on a path, not harming a property or elements on the property, among others.

In some implementations, the rule engine 125 includes one or more algorithms or neural networks. For example, the rule engine 125, as part of the property analysis 223, the feature analysis 217, the movement analysis 219 or the heuristic engine 233, can be trained to detect features. The rule engine 125 can obtain data from the monitor database 227. The rule engine 125 can detect features within the data including whether certain regions are or are not a path. Networks of the rule engine 125 can be trained using labeled image data of paths or virtual model data depicted different paths. Layers, weights, or other parameters of the network can be trained by, e.g., the control unit 101, to make the property analysis 223 more accurately identify features of a property. A difference between predicted identification and training data identifications can be generated by a training device, such as the control unit 101 or other device, to determine how, and by how much, to adjust values of the network. Stochastic gradient descent, backpropagation, among other training methods and techniques can be used to train networks of the rule engine 125 as well as networks of other elements shown in FIG. 2.

In some implementations, the monitor database 227 includes virtual camera feed. For example, the rule engine 125, e.g., as part of the property analysis 223, can obtain the camera feed of the camera 115 and use the camera feed to determine various features of the represented property as well as actions depicted. The camera feed can show elements such as the avatar 117a-b and regions of the property.

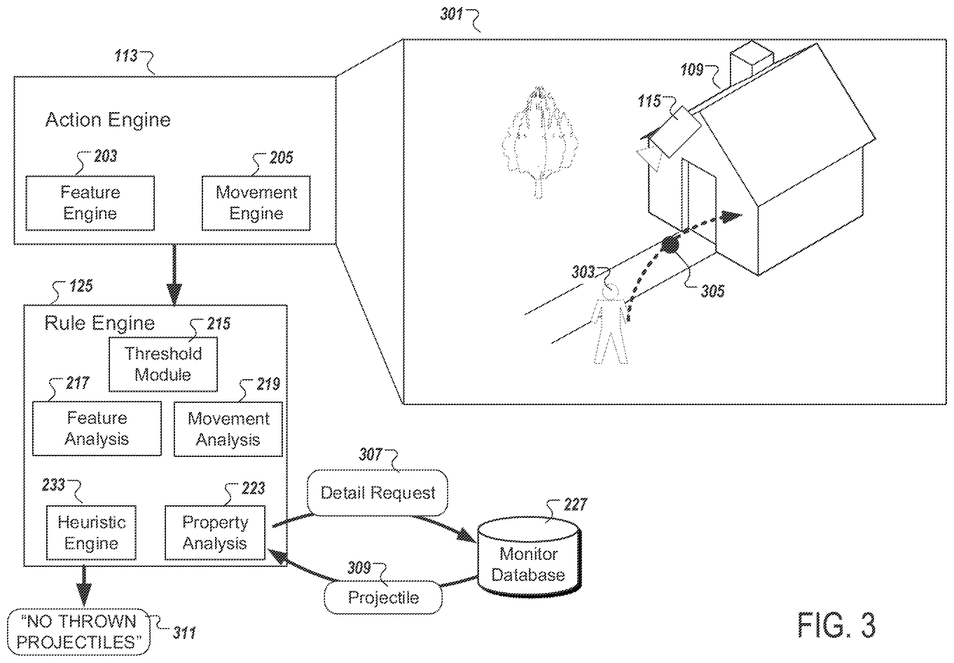

FIG. 3 is a diagram showing an example of the action engine 113 and the rule engine 125 performing feature analysis and movement analysis for monitoring system rule generation. FIG. 3 shows a different action being performed in the same virtual model as shown in FIG. 2. The action is shown graphically in image 301. The action includes the avatar 303 throwing a projectile 305 at the house 109. As discussed in FIG. 1, a user can control the avatar through an interface system. Virtual reality allows the user to show rule violations that may damage elements of a property without actually damaging real property.

The action engine 113 in this case generates the action of the avatar 303 throwing the projectile 305 at the house 109. The rule engine 125 performs analysis on the action and generates rule 311 summarized by the phrase “NO THROWN PROJECTILES.” The rule 311 can be stored as a set of one or more detected features and thresholds corresponding to the features. For example, the rule 311 can indicate a detected object of unspecified size or characteristic moving from a person or other element towards the house 109 at a speed greater than a threshold speed.

Like elements from FIG. 1 and FIG. 2 perform similar operations in FIG. 3. The rule engine 125, e.g., as part of the property analysis 223, queries the monitor database 227 with detail request 307. In some implementations, the monitor database 227 includes virtual footage from the camera 115. For example, the rule engine 125 can detect features in camera footage from the virtual model accessible on the monitor database 227. In some implementations, the monitor database 227 includes preferences of one or more users corresponding to a property. For example, a user can specify certain elements of interest or danger, such as projectiles.

Using the data from the property and the virtual model, the rule engine 125 can detect features affected by the action represented in the virtual model. In this example, the projectile 305 affects the house 109 by hitting it on a front facing side. The avatar 303 is standing off the path leading to the house 109.

Using output from the property analysis 223, the rule engine 125 generates the rule 311. In some implementations, the rule engine 125 generates different rules that take into account other features of the virtual model which can be controlled by a user controlling the virtual model. For example, a user can set a time of day and the time of day setting can be included in the rule such that the rule corresponding to the specific actions is only effective at the time or day setting, e.g., after 5:00 PM.

In some implementations, the monitor database 227 includes notification preferences. For example, the monitor database 227 can include a preference to be notified for all rule violations or all rule violations in a particular area of a property. A user can specify a subset of rules to be notified for. A user can specify rules where the control unit 101, or other device operating a monitoring system, should directly contact authorities.

In some implementations, the control unit 101 generates individual rules for individual activities. For example, one rule for entering the house through a window, another rule for vehicles driving on the lawn. A user can demonstrate each problem-behavior individually (e.g., one or more times) to train one or more networks of the control unit 101 to detect the behavior, which may include actions as well as features.

In some implementations, the control unit 101 groups multiple activities into a single rule. For example, a user can show multiple activities, such as breaking a window, driving on the lawn, a bear in a region of a property, among others. The control unit 101 can generalize one or more shown activities into a single “bad behavior” rule that could encompass the one or more activities.

In some implementations, a user explicitly declares the start and end of the bad behavior. For example, the user can, in virtual reality (VR) perform acceptable activities, e.g., walking up a path or driveway. The user can declare the start of bad behavior, then break a window and enter the house through the broken window, then declare the demonstration completed. The user can declare a start of bad behavior by interfacing with the control unit 101 to provide an indication. Interface can include buttons, touch screens, among other computer interfaces. In some implementations, a user uses voice commands. For example, a user can use a predetermined word, or a word that the control unit 101 determines likely corresponds to a start condition, e.g., “I'm doing bad behavior now”, “Starting bad behavior”, among others. By obtaining declarations from a user declaring a start and end of the bad behavior (or good behavior), the control unit 101 can then focus on the behavior.

In some implementations, a user communicates one or more actions. For example, a user can say, “if I jump over this wall, that's bad.” A microphone input device of the control unit 101 or the device 121 can obtain audio input of the user. In this case, the control unit 101 can perform speech processing to determine an action conveyed in speech. In some implementations, the control unit 101 interprets sign language using visual processing techniques. After obtaining a communication from a user, the control unit 101 can interpret the communication as an action. In some implementations, the control unit 101 generates a virtual reality simulation of the action to confirm, by providing the simulation to a user, the action was correctly interpreted. A user can indicate if the action was correct or not or retry a communication until a provided simulation matches the intended action. In some implementations, the control unit 101 does not provide a visualization. For example, the control unit 101 can directly determine, based on an internal processing of the interpreted action, a corresponding rule using the rule engine 125 as described herein.

In some implementations, a user communicates one or more actions specified for particular users. For example, a user can state, e.g., for a given location, a predefined set of actions are allowed or not allowed for authorized users while another predefined set of actions are allowed or not allowed for unauthorized users. In general, any particular users can be specified by a user including specified users known to the control unit 101 by name or other identifier, e.g., property owner, lawn mower, among others.

In some implementations, bad behavior includes walking into prohibited areas. For example, a user can walk into areas that are determined to be prohibited by the control unit 101. A user can designate certain areas as prohibited for certain persons. In some implementations, bad behavior includes entering a property using an unauthorized path (e.g. entering the house through a window). In some implementations, bad behavior includes causing damage (e.g. breaking a window).

In some implementations, after each demonstration, the control unit 101 provides feedback. For example, the control unit 101 can provide feedback indicating that there is not sufficient data to create a rule. Feedback can include a virtual reality projection of what the interpreted rule looks like. For example, for prohibited regions, a virtual coloring or other designation of a prohibited area could be shown in a virtual model of a property. A user can interface directly with the control unit 101 or use a device communicably connected with the control unit 101 to provide feedback, either confirmation or rejection of the predicted rule. A user can provide additional demonstrations to refine the rule interpretations. In some implementations, a user provides additional declarations to the control unit 101 indicating that an activity or behavior is an additional demonstration to refine a predicted rule.

In some implementations, a user provides acceptable behavior. For example, a user can provide action information, such as the action 123, where the action is an acceptable behavior. Acceptable behavior, similar to non-acceptable behavior, otherwise referred to as bad behavior, can depend on a given property and a user's preferences. In some cases, a user does not declare before starting or stopping an activity. Example acceptable activities can include walking on the sidewalk past a house, walking to the front door and knocking on the door, driving a car and parking in the driveway, driving a car into the garage, among others. In some implementations, actions that generate a security alert are determined based on a comparison of an action to acceptable behavior. For example, the control unit 101 can determine one or more values representing an action depicted either in a virtual model or in reality using sensor data from a monitoring system. The control unit 101 can compare the one or more values to one or more thresholds representing acceptable behavior previously recorded and stored in the control unit 101 or connected device (e.g., walking off the path by 1 foot may not satisfy a difference threshold but 3 feet may satisfy a threshold depending on implementation).

In some implementations, the control unit 101 supplements with real world data. For example, for a property with a system already in place, the control unit 101 can obtain samples of real world footage, e.g., from real world cameras or other sensors, as bad behavior or acceptable behavior. A user, or neural network of the control unit 101, can determine if the real world footage corresponds to bad or acceptable behavior. In some implementations, the control unit 101 obtains this data in the property and monitor information 105. The control unit 101 can provide a user with footage and obtain, from a user through an interface, a determination from the user indicating if the footage is acceptable or not acceptable. In some implementations, the control unit previews outliers from an obtained real world dataset to allow the user to confirm their inclusion into either a set of bad behavior data or a set of good, or acceptable, behavior.

In some implementations, rules are determined based on alert preferences. For example, instead of determining good or bad behavior, a rule can indicate when to notify or send an alert. Most porch or doorbell cameras will notify the user about visitors. That doesn't necessarily mean that visitors are bad. Using VR to demonstrate bad or dangerous behavior has specific benefits (e.g., not having to actually perform potentially dangerous or destructive behavior in the real world), but the description provided herein can apply for training on alert-worthy behavior.

In some implementations, a demonstration, which may include one or more actions, is person specific. For example, during any demonstration (e.g., good, bad, not specified) a user can declare that they are representing themselves, that they are representing any known resident/family member, or that they are representing anyone other than themselves or anyone other than a known family member. A user can specify during the demonstration that certain behavior is acceptable for residents, but not acceptable for non-residents; or even that certain behavior is acceptable for parents, adults, or people over a certain defined age but not children. A corresponding rule, such as the rule 131, can apply to specific people. A user can specify that the actions they are taking are meant to represent, for example, a group of people of a certain number, a person with a certain credential, a person who has taken another defined action previously, a person carrying a particular item, an animal, or a vehicle. A user can specify by input through the device 121, e.g., touch screen, microphone, virtual buttons, among others, or directly to the control unit 101 using a corresponding interface.

In some implementations, the control unit 101 processes data from the virtual model to determine bad or good behavior. For example, algorithms to process image data, feature extraction, among others can be used to determine the elements and movement of people or objects as well as actions performed. In some implementations, the control unit 101 observes normal or acceptable behavior.

In some implementations, the control unit 101 processes data based on determining the type of behavior being demonstrated. For example, the control unit 101 can be pre-tuned to observe specific virtual person movements. The control unit 101 can observe the ground-plane position of a virtual avatar at a given point in time corresponding to an action performed. Depending on the length of time and amount of movement during the activity, the control unit 101 can interpret the activity as a tripwire or area of interest rule where movement of persons is restricted on a property, e.g., restricted to the path to the house 109 in the example of FIG. 1. Multiple demonstrations may help to define the specific coordinates for the restriction. Similarly, if there is little to no movement, the control unit 101 can analyze other features of the model to look for cues such as a window breaking. In some implementations, the control unit 101 looks for cues after a user declares a start or end of an activity. For example, the control unit 101 does not allocate resources unless there is an activity that was performed.

In some implementations, the control unit 101 does not perform computer vision techniques. In some implementations, the control unit 101 does perform computer vision techniques. For example, one possible analysis technique used by the control unit 101 can include analyzing virtual video feed from the virtual model. In some cases, the control unit 101 can obtain specific virtual model information indicating exact movements or changes of features. Because all the effects need to be generated in the virtual model, the control unit 101 already has information stored about the exact activity demonstrated in the virtual model. The control unit 101 can directly obtain this information to determine a given rule.

In some implementations, the control unit 101 obtains information of a property to determine an extent of rule coverage. For example, the control unit 101 can use existing boundaries, geometry, and objects (e.g., gathered by video analysis of the scene or as specified in the virtual model) to infer an extent of rule coverage. For example, the control unit 101 could obtain information indicating boundaries of a sidewalk and lawn to extrapolate from an example of someone walking from a particular point on the sidewalk and crossing the lawn to a more generalized rule that leaving the sidewalk and crossing onto the lawn at any point along the sidewalk is bad or not acceptable. Similarly, a person entering the house through a specific window could be generalized to “a person entering the house through a window is bad.”

When creating tripwires and areas of interest, such as the second region 211 of FIG. 2, the system can leverage the 3D virtual model to, for example, ensure that a rule covers the traversable ground as needed, but does not extend into areas which might cause false detections.

In some implementations, the control unit 101 provides camera positioning suggestions. For example, security system installations can include two parts: camera placement and rule setup. During actions demonstrated in the virtual mode, the control unit 101 can determine that the action demonstrated can't be detected with current cameras or other sensors installed in a real world property. For example, if the user repeatedly demonstrates that entering the house through the living room window is bad and should trigger an alert, the control unit 101 can determine, based on known mountings and sensor installations of a property, e.g., stored in the information 105 or the database 103, that there is no sensor in that part of the property or no sensor that could detect the activity, e.g., no window sensors installed on that particular window.

The control unit 101 can notify a user of the VR that the corresponding real life property monitoring system cannot detect the action and therefore the rule could not be enforced on the property. The control unit 101 can provide information to a user indicating adjustments or additional sensor installations that could alleviate the issues. The control unit 101 can recommend adding a camera or specifically adding a camera placed at a specific position in order to capture the demonstrated activities.

In some implementations, the control unit 101 provides feedback to a device of a user. For example, in addition to or instead of visual representation of a rule (e.g., visual tripwires indicated in the virtual model such as a yellow line virtually imposed in the virtual model indicating a prohibited or acceptable region, visual areas of interest colored or otherwise indicated as prohibited or acceptable), the control unit 101 can provide simulated actions within the virtual model. The simulated actions can be simulated versions of a person performing bad or acceptable behavior in the virtual model, depending on the type of demonstrations provided by a user. For example, if a user is providing bad examples, after one or more demonstrations, the control unit 101 can generalize the activity into an action that would trigger the corresponding rule. The control unit 101 can then provide a virtual reality demonstration of that action to the user. The user can then confirm, based on viewing this simulated demonstration, the corresponding rule determined by the control unit 101. The control unit 101 could also show bystanders or other avatars not breaking the rule. Based on a confirmation obtained from the user that the users breaking and not breaking a rule are correctly defined in a virtual scenario, the control unit 101 can store a generated rule where the rule is subsequently enforced in a monitoring system operated by a control device, such as the control unit 101.

Virtual demonstrations provided by the control unit 101 can provide some advantages in homeowner understanding of the expected system behavior without requiring excessive effort, danger, or damage on the part of the installer. In particular, this can help homeowners understand the distinction between “image plane” and “ground plane” rule specifications, for example, rules based on actions determined within an image compared to rules based on the location of the actions in a “ground plane” of a property. For example, a rule can include an area of interest in a doorway. If the area of interest is defined as “image plane,” then any time pixels representing any part of a person is within the pixels that define that area-of-interest, e.g., doorway, in an image, e.g., captured by a security camera on a property, the control unit 101 can trigger an alert based on an alert preference of the rule regardless of whether the person was inside the doorway or just walking in front of the doorway. If the area of interest is defined as “ground plane,” the control unit 101 can determine a footprint (e.g., the point where the control unit 101 calculates the person's foot to be indicating the point where the person is touching the ground plane of the room) to determine the rule intersection. The control unit 101 can trigger an alert, based on an alert preference of a corresponding rule, when a footprint of the person is calculated to be within the area of interest, e.g., doorway, and not if the person just walks in front of the area of interest.

In some implementations, actions are performed in augmented reality, e.g., instead of or in addition to virtual reality. For example, a user can wear one or more devices in a real world. The one or more devices can obtain data and provide the data to the control unit 101. The data can indicate actions of the user on a property. The control unit 101 can then generate a rule similar to the processes discussed herein in regard to actions taken in a virtual model. In processing action data from an augmented reality system, the control unit 101 can use data directly from device of the augmented reality system or sensors installed at a property.

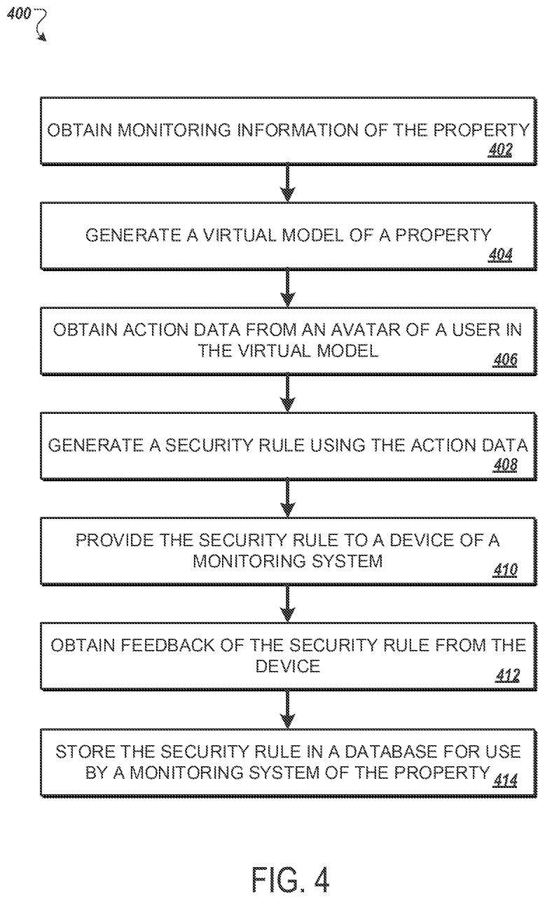

FIG. 4 is a flow diagram illustrating an example of a process 400 for monitoring system rule generation. The process 400 can be performed by a computer, such as the control unit 101.

The process 400 includes obtaining monitoring information of the property (402). For example, the control unit 101 can obtain the property and monitor information 105. The property and monitor information 105 can include details for generating a 3D virtual model of a property, elements of a property, elements of a security system (e.g., types or placements of cameras or other sensors), fully generated virtual models, among others.

The process 400 includes generating a virtual model of a property (404). For example, the model engine 107 of the control unit 101 can generate a virtual model of the property, shown graphically in image 108. The virtual model can include any number of simulated versions of real world elements at a real world property. In some implementations, generating a virtual model includes obtaining a pre-generated virtual model from the property and monitor information 105.

The process 400 includes obtaining action data from an avatar of a user in the virtual model (406). For example, the action engine 113 can render action in the generated virtual model. The action can include movement of avatars, such as avatar 117a-b. The control unit 101 can obtain the movement of the avatar 117a-b. The control unit 101 can obtain the movement of the avatar 117a-b before or after rendering in the virtual model. Action data can include movement or feature information of the avatar. Features can include a uniform of the avatar, face covering, height, pose, gait, limb movement, among others.

The process 400 includes generating a security rule using the action data (408). For example, the rule engine 125 can determine, using the action 123 rendered in the virtual model by the action engine 113, a corresponding rule. In the example of FIG. 1, the rule is “STAY ON THE PATH.” The rule can be stored as one or more mathematical expressions, text string, numerals, among others. The rule can include one or more thresholds or position indicators. For example, a rule can include a position of a path and a threshold of movement. If movement of a person satisfies the threshold, the movement corresponds to walking off the path. This would violate the “STAY ON THE PATH” rule and could trigger an alert based on one or more other thresholds or user preferences.

The process 400 includes providing the security rule to a device of a monitoring system (410). For example, the rule engine 125 can provide the rule prediction 127 to the device 121 or database, such as security rules 133. The rule prediction 127 can include a simulation of rule violations or rule conforming behavior (e.g., a virtual model representation of an avatar performing an action or real world footage obtained from a real world monitoring system of a person or thing performing an action). The simulation can be within the virtual model. The rule prediction 127 can include a representation of a predicted rule, including mathematical expressions, thresholds, text, among others, depending on an implementation of format for a given rule.

The process 400 includes obtaining feedback of the security rule from the device (412). For example, the control unit 101 can obtain the confirmation 129. The confirmation 129 can include input from an interface of the device 121, such as a touch screen or a selection in a virtual reality interface.

The process 400 includes storing the security rule in a database for use by a monitoring system of the property (414). For example, the control unit 101 can store the rule 131, indicated by the text “STAY ON THE PATH” for illustration purposes, in the security rules 133. One or more rules of the security rules 133 can be used by a real world security system to determine rule violations in the real world. In some implementations, the control unit 101 operates a real world security system and can perform both the generation of rules using virtual reality as described herein and the subsequent application of those generated rules in the real world.

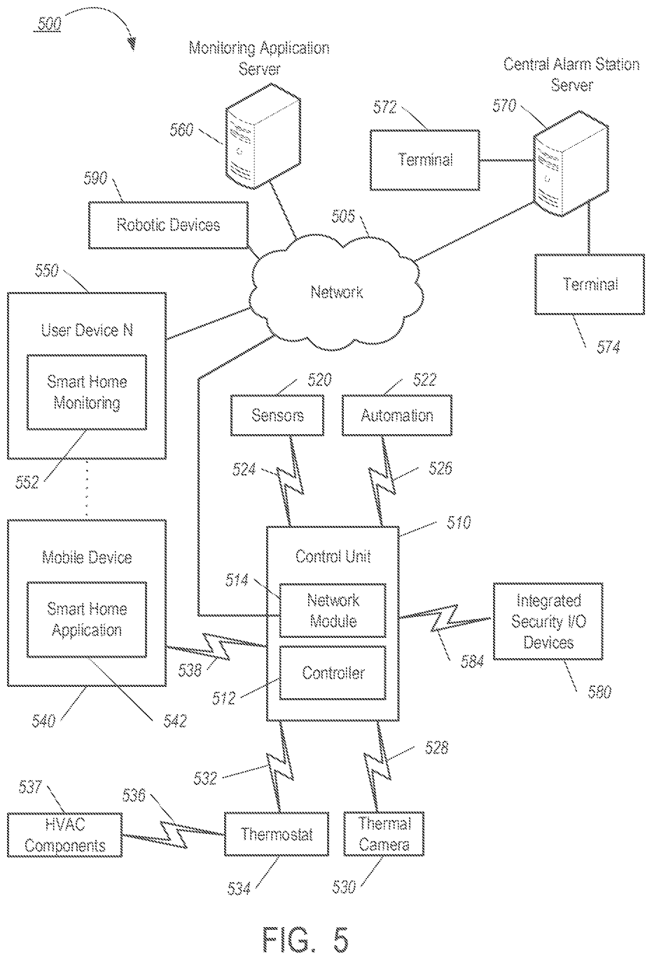

FIG. 5 is a diagram illustrating an example of a property monitoring system 500. In some cases, the property monitoring system 500 may include components of the system 100 of FIG. 1. For example, the control unit 101 may perform operations of the control unit 510.

The network 505 is configured to enable exchange of electronic communications between devices connected to the network 505. For example, the network 505 may be configured to enable exchange of electronic communications between the control unit 510, the one or more user devices 540 and 550, the monitoring server 560, and the central alarm station server 570. The network 505 may include, for example, one or more of the Internet, Wide Area Networks (WANs), Local Area Networks (LANs), analog or digital wired and wireless telephone networks (e.g., a public switched telephone network (PSTN), Integrated Services Digital Network (ISDN), a cellular network, and Digital Subscriber Line (DSL)), radio, television, cable, satellite, or any other delivery or tunneling mechanism for carrying data. The network 505 may include multiple networks or subnetworks, each of which may include, for example, a wired or wireless data pathway. The network 505 may include a circuit-switched network, a packet-switched data network, or any other network able to carry electronic communications (e.g., data or voice communications). For example, the network 505 may include networks based on the Internet protocol (IP), asynchronous transfer mode (ATM), the PSTN, packet-switched networks based on IP, X.25, or Frame Relay, or other comparable technologies and may support voice using, for example, VoIP, or other comparable protocols used for voice communications. The network 505 may include one or more networks that include wireless data channels and wireless voice channels. The network 505 may be a wireless network, a broadband network, or a combination of networks including a wireless network and a broadband network.

The control unit 510 includes a controller 512 and a network module 514. The controller 512 is configured to control a control unit monitoring system (e.g., a control unit system) that includes the control unit 510. In some examples, the controller 512 may include a processor or other control circuitry configured to execute instructions of a program that controls operation of a control unit system. In these examples, the controller 512 may be configured to receive input from sensors, flow meters, or other devices included in the control unit system and control operations of devices included in the household (e.g., speakers, lights, doors, etc.). For example, the controller 512 may be configured to control operation of the network module 514 included in the control unit 510.

The network module 514 is a communication device configured to exchange communications over the network 505. The network module 514 may be a wireless communication module configured to exchange wireless communications over the network 505. For example, the network module 514 may be a wireless communication device configured to exchange communications over a wireless data channel and a wireless voice channel. In this example, the network module 514 may transmit alarm data over a wireless data channel and establish a two-way voice communication session over a wireless voice channel. The wireless communication device may include one or more of a LTE module, a GSM module, a radio modem, cellular transmission module, or any type of module configured to exchange communications in one of the following formats: LTE, GSM or GPRS, CDMA, EDGE or EGPRS, EV-DO or EVDO, UMTS, or IP.

The network module 514 also may be a wired communication module configured to exchange communications over the network 505 using a wired connection. For instance, the network module 514 may be a modem, a network interface card, or another type of network interface device. The network module 514 may be an Ethernet network card configured to enable the control unit 510 to communicate over a local area network and/or the Internet. The network module 514 also may be a voice band modem configured to enable the alarm panel to communicate over the telephone lines of Plain Old Telephone Systems (POTS).

The control unit system that includes the control unit 510 includes one or more sensors 520. For example, the monitoring system may include multiple sensors 520. The sensors 520 may include a lock sensor, a contact sensor, a motion sensor, or any other type of sensor included in a control unit system. The sensors 520 also may include an environmental sensor, such as a temperature sensor, a water sensor, a rain sensor, a wind sensor, a light sensor, a smoke detector, a carbon monoxide detector, an air quality sensor, etc. The sensors 520 further may include a health monitoring sensor, such as a prescription bottle sensor that monitors taking of prescriptions, a blood pressure sensor, a blood sugar sensor, a bed mat configured to sense presence of liquid (e.g., bodily fluids) on the bed mat, etc. In some examples, the health monitoring sensor can be a wearable sensor that attaches to a user in the home. The health monitoring sensor can collect various health data, including pulse, heart rate, respiration rate, sugar or glucose level, bodily temperature, or motion data.

The sensors 520 can also include a radio-frequency identification (RFID) sensor that identifies a particular article that includes a pre-assigned RFID tag.

The system 500 also includes one or more thermal cameras 530 that communicate with the control unit 510. The thermal camera 530 may be an IR camera or other type of thermal sensing device configured to capture thermal images of a scene. For instance, the thermal camera 530 may be configured to capture thermal images of an area within a building or home monitored by the control unit 510. The thermal camera 530 may be configured to capture single, static thermal images of the area and also video thermal images of the area in which multiple thermal images of the area are captured at a relatively high frequency (e.g., thirty images per second). The thermal camera 530 may be controlled based on commands received from the control unit 510. In some implementations, the thermal camera 530 can be an IR camera that captures thermal images by sensing radiated power in one or more IR spectral bands, including NIR, SWIR, MWIR, and/or LWIR spectral bands.

The thermal camera 530 may be triggered by several different types of techniques. For instance, a Passive Infra-Red (PIR) motion sensor may be built into the thermal camera 530 and used to trigger the thermal camera 530 to capture one or more thermal images when motion is detected. The thermal camera 530 also may include a microwave motion sensor built into the camera and used to trigger the thermal camera 530 to capture one or more thermal images when motion is detected. The thermal camera 530 may have a “normally open” or “normally closed” digital input that can trigger capture of one or more thermal images when external sensors (e.g., the sensors 520, PIR, door/window, etc.) detect motion or other events. In some implementations, the thermal camera 530 receives a command to capture an image when external devices detect motion or another potential alarm event. The thermal camera 530 may receive the command from the controller 512 or directly from one of the sensors 520.

In some examples, the thermal camera 530 triggers integrated or external illuminators (e.g., Infra-Red or other lights controlled by the property automation controls 522, etc.) to improve image quality. An integrated or separate light sensor may be used to determine if illumination is desired and may result in increased image quality.

The thermal camera 530 may be programmed with any combination of time/day schedules, monitoring system status (e.g., “armed stay,” “armed away,” “unarmed”), or other variables to determine whether images should be captured or not when triggers occur. The thermal camera 530 may enter a low-power mode when not capturing images. In this case, the thermal camera 530 may wake periodically to check for inbound messages from the controller 512. The thermal camera 530 may be powered by internal, replaceable batteries if located remotely from the control unit 510. The thermal camera 530 may employ a small solar cell to recharge the battery when light is available. Alternatively, the thermal camera 530 may be powered by the controller's 512 power supply if the thermal camera 530 is co-located with the controller 512.

In some implementations, the thermal camera 530 communicates directly with the monitoring server 560 over the Internet. In these implementations, thermal image data captured by the thermal camera 530 does not pass through the control unit 510 and the thermal camera 530 receives commands related to operation from the monitoring server 560.

In some implementations, the system 500 includes one or more visible light cameras, which can operate similarly to the thermal camera 530, but detect light energy in the visible wavelength spectral bands. The one or more visible light cameras can perform various operations and functions within the property monitoring system 500. For example, the visible light cameras can capture images of one or more areas of the property, which the cameras, the control unit, and/or another computer system of the monitoring system 500 can process and analyze.

The system 500 also includes one or more property automation controls 522 that communicate with the control unit to perform monitoring. The property automation controls 522 are connected to one or more devices connected to the system 500 and enable automation of actions at the property. For instance, the property automation controls 522 may be connected to one or more lighting systems and may be configured to control operation of the one or more lighting systems. Also, the property automation controls 522 may be connected to one or more electronic locks at the property and may be configured to control operation of the one or more electronic locks (e.g., control Z-Wave locks using wireless communications in the Z-Wave protocol). Further, the property automation controls 522 may be connected to one or more appliances at the property and may be configured to control operation of the one or more appliances. The property automation controls 522 may include multiple modules that are each specific to the type of device being controlled in an automated manner. The property automation controls 522 may control the one or more devices based on commands received from the control unit 510. For instance, the property automation controls 522 may interrupt power delivery to a particular outlet of the property or induce movement of a smart window shade of the property.

The system 500 also includes thermostat 534 to perform dynamic environmental control at the property. The thermostat 534 is configured to monitor temperature and/or energy consumption of an HVAC system associated with the thermostat 534, and is further configured to provide control of environmental (e.g., temperature) settings. In some implementations, the thermostat 534 can additionally or alternatively receive data relating to activity at the property and/or environmental data at the home, e.g., at various locations indoors and outdoors at the property. The thermostat 534 can directly measure energy consumption of the HVAC system associated with the thermostat, or can estimate energy consumption of the HVAC system associated with the thermostat 534, for example, based on detected usage of one or more components of the HVAC system associated with the thermostat 534. The thermostat 534 can communicate temperature and/or energy monitoring information to or from the control unit 510 and can control the environmental (e.g., temperature) settings based on commands received from the control unit 510.

In some implementations, the thermostat 534 is a dynamically programmable thermostat and can be integrated with the control unit 510. For example, the dynamically programmable thermostat 534 can include the control unit 510, e.g., as an internal component to the dynamically programmable thermostat 534. In addition, the control unit 510 can be a gateway device that communicates with the dynamically programmable thermostat 534. In some implementations, the thermostat 534 is controlled via one or more property automation controls 522.

In some implementations, a module 537 is connected to one or more components of an HVAC system associated with the property, and is configured to control operation of the one or more components of the HVAC system. In some implementations, the module 537 is also configured to monitor energy consumption of the HVAC system components, for example, by directly measuring the energy consumption of the HVAC system components or by estimating the energy usage of the one or more HVAC system components based on detecting usage of components of the HVAC system. The module 537 can communicate energy monitoring information and the state of the HVAC system components to the thermostat 534 and can control the one or more components of the HVAC system based on commands received from the thermostat 534.

In some examples, the system 500 further includes one or more robotic devices 590. The robotic devices 590 may be any type of robot that are capable of moving and taking actions that assist in home monitoring. For example, the robotic devices 590 may include drones that are capable of moving throughout a property based on automated control technology and/or user input control provided by a user. In this example, the drones may be able to fly, roll, walk, or otherwise move about the property. The drones may include helicopter type devices (e.g., quad copters), rolling helicopter type devices (e.g., roller copter devices that can fly and/or roll along the ground, walls, or ceiling) and land vehicle type devices (e.g., automated cars that drive around a property). In some cases, the robotic devices 590 may be robotic devices 590 that are intended for other purposes and merely associated with the system 500 for use in appropriate circumstances. For instance, a robotic vacuum cleaner device may be associated with the monitoring system 500 as one of the robotic devices 590 and may be controlled to take action responsive to monitoring system events.

In some examples, the robotic devices 590 automatically navigate within a property. In these examples, the robotic devices 590 include sensors and control processors that guide movement of the robotic devices 590 within the property. For instance, the robotic devices 590 may navigate within the property using one or more cameras, one or more proximity sensors, one or more gyroscopes, one or more accelerometers, one or more magnetometers, a global positioning system (GPS) unit, an altimeter, one or more sonar or laser sensors, and/or any other types of sensors that aid in navigation about a space. The robotic devices 590 may include control processors that process output from the various sensors and control the robotic devices 590 to move along a path that reaches the desired destination and avoids obstacles. In this regard, the control processors detect walls or other obstacles in the property and guide movement of the robotic devices 590 in a manner that avoids the walls and other obstacles.

In addition, the robotic devices 590 may store data that describes attributes of the property. For instance, the robotic devices 590 may store a floorplan of a building on the property and/or a three-dimensional model of the property that enables the robotic devices 590 to navigate the property. During initial configuration, the robotic devices 590 may receive the data describing attributes of the property, determine a frame of reference to the data (e.g., a property or reference location in the property), and navigate the property based on the frame of reference and the data describing attributes of the property. Further, initial configuration of the robotic devices 590 also may include learning of one or more navigation patterns in which a user provides input to control the robotic devices 590 to perform a specific navigation action (e.g., fly to an upstairs bedroom and spin around while capturing video and then return to a home charging base). In this regard, the robotic devices 590 may learn and store the navigation patterns such that the robotic devices 590 may automatically repeat the specific navigation actions upon a later request.

In some examples, the robotic devices 590 may include data capture and recording devices. In these examples, the robotic devices 590 may include one or more cameras, one or more motion sensors, one or more microphones, one or more biometric data collection tools, one or more temperature sensors, one or more humidity sensors, one or more air flow sensors, and/or any other types of sensors that may be useful in capturing monitoring data related to the property and users at the property. The one or more biometric data collection tools may be configured to collect biometric samples of a person in the property with or without contact of the person. For instance, the biometric data collection tools may include a fingerprint scanner, a hair sample collection tool, a skin cell collection tool, and/or any other tool that allows the robotic devices 590 to take and store a biometric sample that can be used to identify the person (e.g., a biometric sample with DNA that can be used for DNA testing).

In some implementations, one or more of the thermal cameras 530 may be mounted on one or more of the robotic devices 590.

In some implementations, the robotic devices 590 may include output devices. In these implementations, the robotic devices 590 may include one or more displays, one or more speakers, and/or any type of output devices that allow the robotic devices 590 to communicate information to a nearby user.

The robotic devices 590 also may include a communication module that enables the robotic devices 590 to communicate with the control unit 510, each other, and/or other devices. The communication module may be a wireless communication module that allows the robotic devices 590 to communicate wirelessly. For instance, the communication module may be a Wi-Fi module that enables the robotic devices 590 to communicate over a local wireless network at the property. The communication module further may be a 900 MHz wireless communication module that enables the robotic devices 590 to communicate directly with the control unit 510. Other types of short-range wireless communication protocols, such as Bluetooth, Bluetooth LE, Z-wave, Zigbee, etc., may be used to allow the robotic devices 590 to communicate with other devices in the property. In some implementations, the robotic devices 590 may communicate with each other or with other devices of the system 500 through the network 505.

The robotic devices 590 further may include processor and storage capabilities. The robotic devices 590 may include any suitable processing devices that enable the robotic devices 590 to operate applications and perform the actions described throughout this disclosure. In addition, the robotic devices 590 may include solid state electronic storage that enables the robotic devices 590 to store applications, configuration data, collected sensor data, and/or any other type of information available to the robotic devices 590.

The robotic devices 590 can be associated with one or more charging stations. The charging stations may be located at a predefined home base or reference locations at the property. The robotic devices 590 may be configured to navigate to the charging stations after completion of tasks needed to be performed for the monitoring system 500. For instance, after completion of a monitoring operation or upon instruction by the control unit 510, the robotic devices 590 may be configured to automatically fly to and land on one of the charging stations. In this regard, the robotic devices 590 may automatically maintain a fully charged battery in a state in which the robotic devices 590 are ready for use by the monitoring system 500.

The charging stations may be contact-based charging stations and/or wireless charging stations. For contact-based charging stations, the robotic devices 590 may have readily accessible points of contact that the robotic devices 590 are capable of positioning and mating with a corresponding contact on the charging station. For instance, a helicopter type robotic device 590 may have an electronic contact on a portion of its landing gear that rests on and mates with an electronic pad of a charging station when the helicopter type robotic device 590 lands on the charging station. The electronic contact on the robotic device 590 may include a cover that opens to expose the electronic contact when the robotic device 590 is charging and closes to cover and insulate the electronic contact when the robotic device is in operation.

For wireless charging stations, the robotic devices 590 may charge through a wireless exchange of power. In these cases, the robotic devices 590 need only locate themselves closely enough to the wireless charging stations for the wireless exchange of power to occur. In this regard, the positioning needed to land at a predefined home base or reference location in the property may be less precise than with a contact based charging station. Based on the robotic devices 590 landing at a wireless charging station, the wireless charging station outputs a wireless signal that the robotic devices 590 receive and convert to a power signal that charges a battery maintained on the robotic devices 590.

In some implementations, each of the robotic devices 590 has a corresponding and assigned charging station such that the number of robotic devices 590 equals the number of charging stations. In these implementations, the robotic devices 590 always navigate to the specific charging station assigned to that robotic device. For instance, a first robotic device 590 may always use a first charging station and a second robotic device 590 may always use a second charging station.

In some examples, the robotic devices 590 may share charging stations. For instance, the robotic devices 590 may use one or more community charging stations that are capable of charging multiple robotic devices 590. The community charging station may be configured to charge multiple robotic devices 590 in parallel. The community charging station may be configured to charge multiple robotic devices 590 in serial such that the multiple robotic devices 590 take turns charging and, when fully charged, return to a predefined home base or reference location in the property that is not associated with a charger. The number of community charging stations may be less than the number of robotic devices 590.

Also, the charging stations may not be assigned to specific robotic devices 590 and may be capable of charging any of the robotic devices 590. In this regard, the robotic devices 590 may use any suitable, unoccupied charging station when not in use. For instance, when one of the robotic devices 590 has completed an operation or is in need of battery charge, the control unit 510 references a stored table of the occupancy status of each charging station and instructs the robotic device 590 to navigate to the nearest charging station that is unoccupied.

The system 500 further includes one or more integrated security devices 580. The one or more integrated security devices may include any type of device used to provide alerts based on received sensor data. For instance, the one or more control units 510 may provide one or more alerts to the one or more integrated security input/output devices 580. Additionally, the one or more control units 510 may receive one or more sensor data from the sensors 520 and determine whether to provide an alert to the one or more integrated security input/output devices 580.

The sensors 520, the property automation controls 522, the thermal camera 530, the thermostat 534, and the integrated security devices 580 may communicate with the controller 512 over communication links 524, 526, 528, 532, and 584. The communication links 524, 526, 528, 532, and 584 may be a wired or wireless data pathway configured to transmit signals from the sensors 520, the property automation controls 522, the thermal camera 530, the thermostat 534, and the integrated security devices 580 to the controller 512. The sensors 520, the property automation controls 522, the thermal camera 530, the thermostat 534, and the integrated security devices 580 may continuously transmit sensed values to the controller 512, periodically transmit sensed values to the controller 512, or transmit sensed values to the controller 512 in response to a change in a sensed value.

The communication links 524, 526, 528, 532, and 584 may include a local network. The sensors 520, the property automation controls 522, the thermal camera 530, the thermostat 534, and the integrated security devices 580, and the controller 512 may exchange data and commands over the local network. The local network may include 802.11 “Wi-Fi” wireless Ethernet (e.g., using low-power Wi-Fi chipsets), Z-Wave, Zigbee, Bluetooth, “Homeplug” or other “Powerline” networks that operate over AC wiring, and a Category 5 (CAT5) or Category 6 (CAT6) wired Ethernet network. The local network may be a mesh network constructed based on the devices connected to the mesh network.

The monitoring server 560 is one or more electronic devices configured to provide monitoring services by exchanging electronic communications with the control unit 510, the one or more user devices 540 and 550, and the central alarm station server 570 over the network 505. For example, the monitoring server 560 may be configured to monitor events (e.g., alarm events) generated by the control unit 510. In this example, the monitoring server 560 may exchange electronic communications with the network module 514 included in the control unit 510 to receive information regarding events (e.g., alerts) detected by the control unit 510. The monitoring server 560 also may receive information regarding events (e.g., alerts) from the one or more user devices 540 and 550.

In some examples, the monitoring server 560 may route alert data received from the network module 514 or the one or more user devices 540 and 550 to the central alarm station server 570. For example, the monitoring server 560 may transmit the alert data to the central alarm station server 570 over the network 505.

The monitoring server 560 may store sensor data, thermal image data, and other monitoring system data received from the monitoring system and perform analysis of the sensor data, thermal image data, and other monitoring system data received from the monitoring system. Based on the analysis, the monitoring server 560 may communicate with and control aspects of the control unit 510 or the one or more user devices 540 and 550.

The monitoring server 560 may provide various monitoring services to the system 500. For example, the monitoring server 560 may analyze the sensor, thermal image, and other data to determine an activity pattern of a resident of the property monitored by the system 500. In some implementations, the monitoring server 560 may analyze the data for alarm conditions or may determine and perform actions at the property by issuing commands to one or more of the automation controls 522, possibly through the control unit 510.

The central alarm station server 570 is an electronic device configured to provide alarm monitoring service by exchanging communications with the control unit 510, the one or more mobile devices 540 and 550, and the monitoring server 560 over the network 505. For example, the central alarm station server 570 may be configured to monitor alerting events generated by the control unit 510. In this example, the central alarm station server 570 may exchange communications with the network module 514 included in the control unit 510 to receive information regarding alerting events detected by the control unit 510. The central alarm station server 570 also may receive information regarding alerting events from the one or more mobile devices 540 and 550 and/or the monitoring server 560.

The central alarm station server 570 is connected to multiple terminals 572 and 574. The terminals 572 and 574 may be used by operators to process alerting events. For example, the central alarm station server 570 may route alerting data to the terminals 572 and 574 to enable an operator to process the alerting data. The terminals 572 and 574 may include general-purpose computers (e.g., desktop personal computers, workstations, or laptop computers) that are configured to receive alerting data from a server in the central alarm station server 570 and render a display of information based on the alerting data. For instance, the controller 512 may control the network module 514 to transmit to the central alarm station server 570, alerting data indicating that a sensor 520 detected motion from a motion sensor via the sensors 520. The central alarm station server 570 may receive the alerting data and route the alerting data to the terminal 572 for processing by an operator associated with the terminal 572. The terminal 572 may render a display to the operator that includes information associated with the alerting event (e.g., the lock sensor data, the motion sensor data, the contact sensor data, etc.) and the operator may handle the alerting event based on the displayed information.

In some implementations, the terminals 572 and 574 may be mobile devices or devices designed for a specific function. Although FIG. 5 illustrates two terminals for brevity, actual implementations may include more (and, perhaps, many more) terminals.

The one or more authorized user devices 540 and 550 are devices that host and display user interfaces. For instance, the user device 540 is a mobile device that hosts or runs one or more native applications (e.g., the smart home application 542). The user device 540 may be a cellular phone or a non-cellular locally networked device with a display. The user device 540 may include a cell phone, a smart phone, a tablet PC, a personal digital assistant (“PDA”), or any other portable device configured to communicate over a network and display information. For example, implementations may also include Blackberry-type devices (e.g., as provided by Research in Motion), electronic organizers, iPhone-type devices (e.g., as provided by Apple), iPod devices (e.g., as provided by Apple) or other portable music players, other communication devices, and handheld or portable electronic devices for gaming, communications, and/or data organization. The user device 540 may perform functions unrelated to the monitoring system, such as placing personal telephone calls, playing music, playing video, displaying pictures, browsing the Internet, maintaining an electronic calendar, etc.

The user device 540 includes a smart home application 542. The smart home application 542 refers to a software/firmware program running on the corresponding mobile device that enables the user interface and features described throughout. The user device 540 may load or install the smart home application 542 based on data received over a network or data received from local media. The smart home application 542 runs on mobile devices platforms, such as iPhone, iPod touch, Blackberry, Google Android, Windows Mobile, etc. The smart home application 542 enables the user device 540 to receive and process image and sensor data from the monitoring system.

The user device 550 may be a general-purpose computer (e.g., a desktop personal computer, a workstation, or a laptop computer) that is configured to communicate with the monitoring server 560 and/or the control unit 510 over the network 505. The user device 550 may be configured to display a smart home user interface 552 that is generated by the user device 550 or generated by the monitoring server 560. For example, the user device 550 may be configured to display a user interface (e.g., a web page) provided by the monitoring server 560 that enables a user to perceive images captured by the thermal camera 530 and/or reports related to the monitoring system. Although FIG. 5 illustrates two user devices for brevity, actual implementations may include more (and, perhaps, many more) or fewer user devices.

The smart home application 542 and the smart home user interface 552 can allow a user to interface with the property monitoring system 500, for example, allowing the user to view monitoring system settings, adjust monitoring system parameters, customize monitoring system rules, and receive and view monitoring system messages.

In some implementations, the one or more user devices 540 and 550 communicate with and receive monitoring system data from the control unit 510 using the communication link 538. For instance, the one or more user devices 540 and 550 may communicate with the control unit 510 using various local wireless protocols such as Wi-Fi, Bluetooth, Z-wave, Zigbee, HomePlug (ethernet over power line), or wired protocols such as Ethernet and USB, to connect the one or more user devices 540 and 550 to local security and automation equipment. The one or more user devices 540 and 550 may connect locally to the monitoring system and its sensors and other devices. The local connection may improve the speed of status and control communications because communicating through the network 505 with a remote server (e.g., the monitoring server 560) may be significantly slower.

Although the one or more user devices 540 and 550 are shown as communicating with the control unit 510, the one or more user devices 540 and 550 may communicate directly with the sensors 520 and other devices controlled by the control unit 510. In some implementations, the one or more user devices 540 and 550 replace the control unit 510 and perform the functions of the control unit 510 for local monitoring and long range/offsite communication.

In other implementations, the one or more user devices 540 and 550 receive monitoring system data captured by the control unit 510 through the network 505. The one or more user devices 540, 550 may receive the data from the control unit 510 through the network 505 or the monitoring server 560 may relay data received from the control unit 510 to the one or more user devices 540 and 550 through the network 505. In this regard, the monitoring server 560 may facilitate communication between the one or more user devices 540 and 550 and the monitoring system 500.

In some implementations, the one or more user devices 540 and 550 may be configured to switch whether the one or more user devices 540 and 550 communicate with the control unit 510 directly (e.g., through link 538) or through the monitoring server 560 (e.g., through network 505) based on a location of the one or more user devices 540 and 550. For instance, when the one or more user devices 540 and 550 are located close to the control unit 510 and in range to communicate directly with the control unit 510, the one or more user devices 540 and 550 use direct communication. When the one or more user devices 540 and 550 are located far from the control unit 510 and not in range to communicate directly with the control unit 510, the one or more user devices 540 and 550 use communication through the monitoring server 560.

Although the one or more user devices 540 and 550 are shown as being connected to the network 505, in some implementations, the one or more user devices 540 and 550 are not connected to the network 505. In these implementations, the one or more user devices 540 and 550 communicate directly with one or more of the monitoring system components and no network (e.g., Internet) connection or reliance on remote servers is needed.

In some implementations, the one or more user devices 540 and 550 are used in conjunction with only local sensors and/or local devices in a house. In these implementations, the system 500 includes the one or more user devices 540 and 550, the sensors 520, the property automation controls 522, the thermal camera 530, and the robotic devices 590. The one or more user devices 540 and 550 receive data directly from the sensors 520, the property automation controls 522, the thermal camera 530, and the robotic devices 590 (i.e., the monitoring system components) and sends data directly to the monitoring system components. The one or more user devices 540, 550 provide the appropriate interfaces/processing to provide visual surveillance and reporting.

In other implementations, the system 500 further includes network 505 and the sensors 520, the property automation controls 522, the thermal camera 530, the thermostat 534, and the robotic devices 590 are configured to communicate sensor and image data to the one or more user devices 540 and 550 over network 505 (e.g., the Internet, cellular network, etc.). In yet another implementation, the sensors 520, the property automation controls 522, the thermal camera 530, the thermostat 534, and the robotic devices 590 (or a component, such as a bridge/router) are intelligent enough to change the communication pathway from a direct local pathway when the one or more user devices 540 and 550 are in close physical proximity to the sensors 520, the property automation controls 522, the thermal camera 530, the thermostat 534, and the robotic devices 590 to a pathway over network 505 when the one or more user devices 540 and 550 are farther from the sensors 520, the property automation controls 522, the thermal camera 530, the thermostat 534, and the robotic devices 590. In some examples, the system leverages GPS information from the one or more user devices 540 and 550 to determine whether the one or more user devices 540 and 550 are close enough to the monitoring system components to use the direct local pathway or whether the one or more user devices 540 and 550 are far enough from the monitoring system components that the pathway over network 505 is required. In other examples, the system leverages status communications (e.g., pinging) between the one or more user devices 540 and 550 and the sensors 520, the property automation controls 522, the thermal camera 530, the thermostat 534, and the robotic devices 590 to determine whether communication using the direct local pathway is possible. If communication using the direct local pathway is possible, the one or more user devices 540 and 550 communicate with the sensors 520, the property automation controls 522, the thermal camera 530, the thermostat 534, and the robotic devices 590 using the direct local pathway. If communication using the direct local pathway is not possible, the one or more user devices 540 and 550 communicate with the monitoring system components using the pathway over network 505.

In some implementations, the system 500 provides end users with access to thermal images captured by the thermal camera 530 to aid in decision making. The system 500 may transmit the thermal images captured by the thermal camera 530 over a wireless WAN network to the user devices 540 and 550. Because transmission over a wireless WAN network may be relatively expensive, the system 500 can use several techniques to reduce costs while providing access to significant levels of useful visual information (e.g., compressing data, down-sampling data, sending data only over inexpensive LAN connections, or other techniques).

In some implementations, a state of the monitoring system and other events sensed by the monitoring system may be used to enable/disable video/image recording devices (e.g., the thermal camera 530 or other cameras of the system 500). In these implementations, the thermal camera 530 may be set to capture thermal images on a periodic basis when the alarm system is armed in an “armed away” state, but set not to capture images when the alarm system is armed in an “armed stay” or “unarmed” state. In addition, the thermal camera 530 may be triggered to begin capturing thermal images when the alarm system detects an event, such as an alarm event, a door-opening event for a door that leads to an area within a field of view of the thermal camera 530, or motion in the area within the field of view of the thermal camera 530. In other implementations, the thermal camera 530 may capture images continuously, but the captured images may be stored or transmitted over a network when needed.

The described systems, methods, and techniques may be implemented in digital electronic circuitry, computer hardware, firmware, software, or in combinations of these elements. Apparatus implementing these techniques may include appropriate input and output devices, a computer processor, and a computer program product tangibly embodied in a machine-readable storage device for execution by a programmable processor. A process implementing these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, a processor will receive instructions and data from a read-only memory and/or a random-access memory. Storage devices suitable for tangibly embodying computer program instructions and data include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially designed ASICs (application-specific integrated circuits).

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure. A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

What is claimed is:

1. A method comprising:
presenting a virtual model of a property that includes a monitoring system;
obtaining action data from a computer generated avatar in the virtual model;
generating a security rule for the monitoring system using the action data from the computer generated avatar in the virtual model; and
providing, to the monitoring system, the security rule to cause the monitoring system to generate, using the security rule and sensor data from the property received by the monitoring system, a security alert.

2. The method of claim 1, wherein generating the security rule using the action data comprises:
determining movement vectors of the avatar moving in the virtual model; and
determining, using the movement vectors, regions represented in the virtual model accessed by the avatar.

3. The method of claim 1, wherein generating the security rule using the action data comprises:
generating a virtual image stream representing images from a viewpoint corresponding to a real camera of the monitoring system of the property; and
generating, using the virtual image stream, the security rule.

4. The method of claim 1, comprising:
obtaining monitoring information of the monitoring system of the property; and
generating the virtual model of the property using the monitoring information of the monitoring system of the property.

5. The method of claim 1, comprising:
obtaining user input provided by a user input device representing the action data of the computer generated avatar in the virtual model, wherein the computer generated avatar is controlled using the user input.

6. The method of claim 1, comprising:
obtaining user input requesting that one or more actions represented in the action data trigger one or more security alerts, wherein the one or more security alerts include the security alert.

7. The method of claim 1, comprising:
providing the security rule to a device of the monitoring system;
obtaining feedback of the security rule from the device; and
updating, in response to obtaining the feedback of the security rule, a security rule database for use by the monitoring system of the property.

8. The method of claim 7, wherein updating the security rule database comprises:
storing the security rule in the security rule database.

9. The method of claim 7, comprising:
updating, in response to obtaining the feedback of the security rule, the security rule; and
updating the security rule database by storing the updated security rule in the security rule database.

10. The method of claim 7, wherein providing the security rule to the device of the monitoring system comprises:
providing data indicating a virtual representation of the avatar performing an action in the virtual model to a device of a user.

11. The method of claim 1, wherein generating the security alert using the security rule comprises:
transmitting sensor data from the monitoring system of the property to a device of the monitoring system, wherein the sensor data represents an action satisfying one or more thresholds of the security rule.

12. The method of claim 1, wherein generating the security rule using the action data comprises:
determining a plurality of thresholds including one or more thresholds for movement of an object and one or more thresholds for features of the object.

13. The method of claim 12, wherein determining the plurality of thresholds comprises:
determining the one or more thresholds for movement including a position threshold indicating whether a person is moving on or off a pathway.

14. The method of claim 1, wherein generating the security rule comprises:
detecting input indicating an identifier for a specific person;
determining, using the action data from the computer generated avatar in the virtual model, an action for the specific person; and
generating the security rule that (i) includes the identifier for the specific person and (ii) identifies the action that applies to the specific person using the identifier.

15. The method of claim 1, wherein generating the virtual model of the property comprises:
generating a virtual representation of a home and one or more elements within a threshold distance of the home.

16. The method of claim 1, wherein obtaining the action data from the computer generated avatar in the virtual model comprises:
obtaining actions of the computer generated avatar walking off a path at the property in the virtual model of the property.

17. The method of claim 1, comprising:
providing data captured by the monitoring system of the property to a device of a user; and
obtaining feedback from the device of the user indicating if the data captured by the monitoring system of the property includes acceptable or not acceptable actions.

18. The method of claim 1, comprising:
obtaining audio input as at least part of the action data; and
generating, using the audio input, the security rule for the monitoring system.

19. One or more non-transitory computer-readable media storing one or more instructions executable by a computer system to perform operations comprising:
presenting a virtual model of a monitoring system of a property;
obtaining action data from a computer generated avatar in the virtual model;
generating a security rule for the monitoring system using the action data from the computer generated avatar in the virtual model; and
providing, to the monitoring system, the security rule to cause the monitoring system to generate, using the security rule and sensor data from the property received by the monitoring system, a security alert.

20. A system comprising one or more computers and one or more storage devices on which are stored instructions that are operable, when executed by the one or more computers, to cause the one or more computers to perform operations comprising:
presenting a virtual model of a monitoring system of a property;
obtaining action data from a computer generated avatar in the virtual model;
generating a security rule for the monitoring system using the action data from the computer generated avatar in the virtual model; and
providing, to the monitoring system, the security rule to cause the monitoring system to generate, using the security rule and sensor data from the property received by the monitoring system, a security alert.
